(19) United States
(12) Patent Application Publication
(10) Pub. No.: US 2012/0181414 A1
(43) Pub. Date: Jul. 19, 2012

(54) ROTOR SUPPORT MECHANISM AND IMAGE FORMATION APPARATUS

(75) Inventor: Hiroshi YUASA, Tokyo (JP)

(73) Assignee: OKI DATA CORPORATION, Tokyo (JP)

(21) Appl. No.: 13/339,665

(22) Filed: Dec. 29, 2011

(30) Foreign Application Priority Data
Jan. 13, 2011 (JP) 2011-004895

(51) Int. Cl. F16M 13/00; G03G 15/00

(52) U.S. Cl. 248/672; 399/92

(57) ABSTRACT

A rotor support structure includes: an operable unit including a rotor and a casing rotatably supporting the rotor; a support member includes a support member main body configured to accommodate therein the operable unit, and an attachment part to attach the support member main body to a base; and a press part configured, when the support member with the operable unit accommodated therein is attached to the base, to press the operable unit to hold the operable unit in the support member main body.

### CROSS REFERENCE TO RELATED APPLICATIONS

This application claims priority based on 35 U.S.C. 119 from prior Japanese Patent Application No. 2011-004895 filed on Jan. 13, 2011, entitled “ROTOR SUPPORT MECHANISM AND IMAGE FORMATION APPARATUS”, the entire contents of which are incorporated herein by reference.

### BACKGROUND OF THE INVENTION

1. Field of the Invention

The invention relates to a rotor support mechanism and an image formation apparatus.

2. Description of Related Art

A conventional image forming apparatus, such as a printer, a copy machine, a facsimile machine, and a multi function peripheral/printer (MFP), operates as follows. A charge roller uniformly charges a surface of a photosensitive drum, a LED head exposes light onto the uniformly charged surface of the photosensitive drum thereby forming an electrostatic latent image thereon, a development device supplies toner to the electrostatic latent image thereby forming (developing) a toner image on the surface of the photosensitive drum, a transfer roller transfers the toner image onto a paper sheet, and then a fixation unit fixes the toner image to the paper sheet, thereby forming an image on the paper sheet.

The fixation unit includes a fixation roller having therein a heater and a pressure roller pressed against the fixation roller. When the paper sheet is conveyed between the fixation roller and the pressure roller, the fixation roller heats the toner image on the paper sheet and the pressure roller presses the paper sheet against the fixation roller, thereby fixing the toner image onto the paper sheet.

Since the fixation roller includes the heater therein, the inside temperature of the printer tends to be high due to the heat generated by the heater.

To prevent the inside temperature from becoming too high, the printer includes a ventilation fan having a rotor to discharge the air inside the printer to the outside thereof (See, for example, Japanese Patent Application Laid-Open No. 2000-172031).

### SUMMARY OF THE INVENTION

However, since the fan is fixed to the housing by means of screws in the conventional printer, the operation of attaching and detaching the fan may be troublesome.

An object of an embodiment of the invention is to simplify the operation of attachment and detachment of an operable unit having a rotor to a base.

An aspect of the invention is a rotor support mechanism that includes: an operable unit including a rotor and a casing rotatably supporting the rotor; a support member that includes a support member main body configured to accommodate therein the operable unit and an attachment part to attach the support member main body to a base; and a press part configured, when the support member with the operable unit accommodated therein is attached to the base, to press the operable unit to hold the operable unit in the support member main body.

According to this aspect, the workability of attaching and detaching the operable unit can be improved.

### BRIEF DESCRIPTION OF THE DRAWINGS

FIG. 1 is a sectional view of a rotor support mechanism according to a first embodiment of the invention, illustrating a state where a fan unit is attached.

FIG. 2 is a conceptual diagram of a printer according to the first embodiment of the invention.

FIG. 3 is an exploded perspective view of the first embodiment, illustrating a state before the fan unit is attached.

FIG. 4 is a perspective view of a fan holder according to the first embodiment of the invention.

FIG. 5 is a perspective view of a part of the fan holder according to the first embodiment of the invention.

FIG. 6 is a sectional view of the fan unit according to the first embodiment of the invention.

FIG. 7 is a sectional view illustrating a part of a fan unit according to a second embodiment of the invention.

FIG. 8 is a perspective view illustrating a part of a fan holder according to a third embodiment of the invention.

FIG. 9 is a sectional view of a fan unit according to the third embodiment of the invention.

FIG. 10 is a sectional view of a rotor support mechanism according to the third embodiment of the invention, illustrating a state where the fan unit is attached.

FIG. 11 is a view for explaining a method of attaching and detaching a fan to and from a fan holder according to the third embodiment of the invention.

FIG. 12 is a sectional view of a part of a fan unit according to a fourth embodiment of the invention.

FIG. 13 is a sectional view of a part of a rotor support mechanism according to the fourth embodiment of the invention, illustrating a state where the fan unit is attached.

FIG. 14 is a perspective view illustrating a part of a housing member according to a fifth embodiment of the invention.

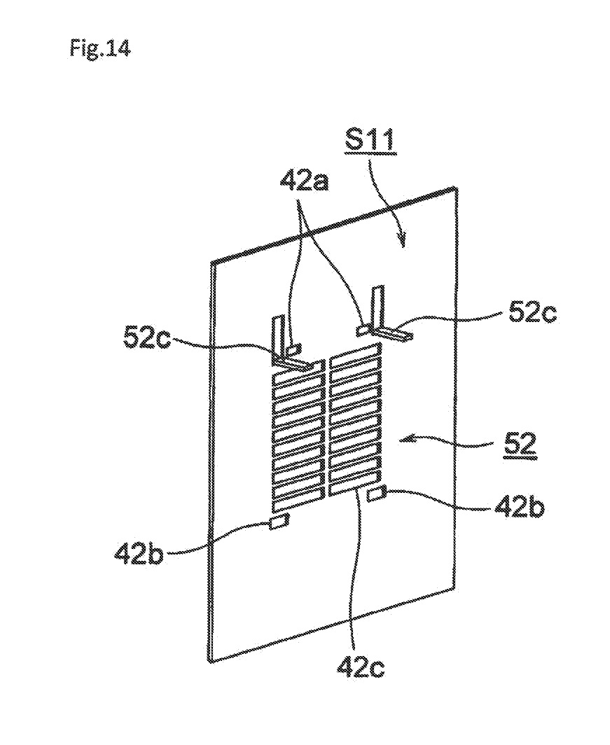

FIG. 15 is a sectional view illustrating a fan unit according to the fifth embodiment of the invention.

FIG. 16 is a sectional view of a part of a rotor support mechanism according to the fifth embodiment of the invention, illustrating a state where the fan unit is attached.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Descriptions of the following embodiments are given for a printer as an image formation apparatus.

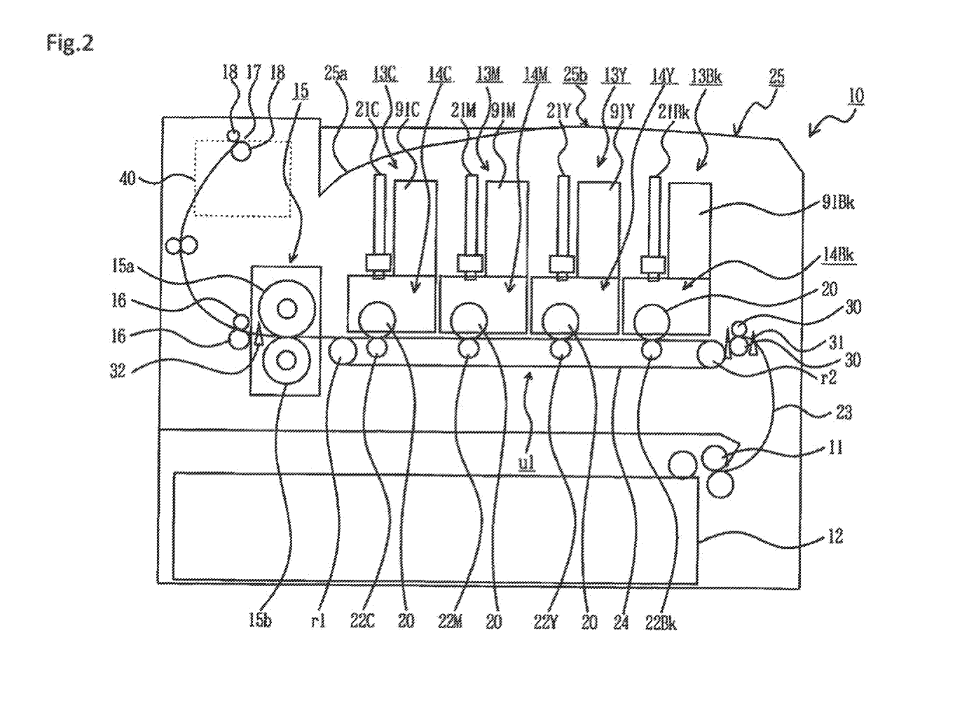

FIG. 2 is a conceptual diagram of a printer of the first embodiment of the invention.

In FIG. 2, reference numeral 10 designates the printer (the image formation apparatus). Reference numeral 11 designates a sheet feed roller, serving as a medium feeder, to be rotated by a feed motor or a feed driver to feed sheets (not shown) serving as media. Reference numeral 12 designates a sheet cassette to accommodate therein sheets being stacked, and reference numeral 23 designates a conveyance path in which the sheet is to be conveyed. Reference numerals 13Bk, 13Y, 13M, and 13C designate image formation units for black, yellow, magenta, and cyan, respectively, and reference numeral 25 designates a housing of image formation apparatus 10.

Image formation units 13Bk, 13Y, 13M, and 13C include image formation unit main parts 14Bk, 14Y, 14M, and 14C which are main parts of image formation units 13Bk, 13Y, 13M, and 13C and toner cartridges 91Bk, 91Y, 91M, and 91C, serving as developer containers, detachably attached to image formation unit main parts 14Bk, 14Y, 14M, and 14C.

Each image formation unit main part 14Bk, 14Y, 14M, 14C includes: photosensitive drum 20 serving as an image carrier; a charge roller (not shown) serving as a charge device configured to uniformly charge the surface of photosensitive drum 20; a development roller (not shown) serving as a developer carrier configured to attach toner to a latent image (an electrostatic latent image) formed on the surface of photosensitive drum 20 thereby forming a toner image serving as a developer image; and a toner supply roller (not shown) serving as a developer supply member configured to supply the toner to the development roller. Note that the development roller, the toner supply roller, and the like make up a development unit or a development device.

LED heads 21Bk, 21Y, 21M, and 21C, serving as an exposure device, are provided opposite to respective photosensitive drums 20 so as to emit light to the surface of each respective photosensitive drum 20 and thereby form an electrostatic latent image on the surface of each photosensitive drum 20.

In image formation units 13Bk, 13Y, 13M, and 13C, the charge rollers uniformly charge the surfaces of photosensitive drums 20, LED heads 21Bk, 21Y, 21M, and 21C emit light to the uniformly charged surfaces of photosensitive drums 20 thereby forming electrostatic latent images on photosensitive drums 20, and then the development rollers supply toner of respective colors to the electrostatic latent images thereby forming (developing) toner images of respective colors.

Image transfer unit ul is provided below image formation units 13Bk, 13Y, 13M, and 13C. Image transfer unit ul includes: drive roller r1 serving as a first roller; driven roller r2 serving as a second roller; conveyance belt 24 serving as a conveyance member, tensely stretched between drive roller r1 and driven roller r2; and transfer rollers 22Bk, 22Y, 22M, and 22C, serving as an image transferor, provided opposite to photosensitive drums 20 such that the upper line of conveyance belt 24 is positioned between photosensitive drums 20 and transfer rollers 22Bk, 22Y, 22M, and 22C. Rotation of drive roller r1, driven by an unillustrated conveyance driver, makes conveyance belt 24 operate in a rotating manner.

Resist roller pair 30, serving as a print timing adjuster, is provided adjacent to, and upstream from, image formation unit 13Bk in the medium conveyance direction. Medium detector 31 detects if a medium has been conveyed to resist roller pair 30. Resist roller pair 30 conveys the medium downstream to be synchronized with the timing of the image formation by image formation units 13Bk, 13Y, 13M, and 13C.

Fixation unit 15, serving as a fixation device or a fuser, is provided downstream from image formation unit 13C in the medium conveyance direction. Fixation unit 15 includes: heat roller 15a serving as a first roller and having therein a heater or heating element (not shown) ; and press roller 15b serving as a second roller. Medium detector 32 is provided to detect if the medium has been passed through fixation unit 15.

Discharge roller pairs 16 and 18 are provided downstream from fixation unit 15 in the medium conveyance direction. Medium outlet 17 or a medium discharge port is formed adjacent to discharge roller pair 18. Stacker 25a is formed at upper cover 25b, on which the media that are discharged from medium outlet 17 are to be stacked.

Since fixation unit 15, as a heat source, is provided in housing 25 of image formation apparatus 10, the inside temperature of image formation apparatus 10 tends to be high due to the heat generated by fixation unit 15. If the temperature inside image formation apparatus 10 becomes too high, image formation units 13Bk, 13Y, 13M, and 13C are affected by the high temperature, which may cause degradation of the image quality. To prevent this, the embodiment attaches fan unit 40, serving as a air-exhauster or a ventilation device, to housing 25 in the vicinity of medium outlet 17, so that fan unit 40 can discharge air from the inside to the outside of image formation apparatus 10, thereby preventing the temperature inside image formation apparatus 10 from becoming too high.

Next, operation of the printer having the above configuration will be described.

First, sheets stacked in sheet cassette 12 are fed, by sheet feed roller 11, one by one, toward image formation units 13Bk, 13Y, 13M, and 13C. When medium detector 31 detects that the sheet has reached resist roller pair 30, resist roller pair 30 conveys the sheet in the downstream direction to be synchronized with the timing of forming images by image formation units 13Bk, 13Y, 13M, and 13C.

Next, the sheet is conveyed between photosensitive drums 20 and transfer rollers 22Bk, 22Y, 22M, and 22C, while toner images of respective colors formed on photosensitive drums 20 are sequentially superimposed on the sheet by means of transfer rollers 22Bk, 22Y, 22M, and 22C, thereby forming a multi-color toner image on the sheet.

The sheet having the multi-color toner image is then conveyed to fixation unit 15. In fixation unit 15, the toner image is heated by heat roller 15a and pressed by press roller 15b, thereby fixing the multi-color toner image to the sheet, that is, forming a multi-color image on the sheet.

The sheet that is discharged from fixation unit 15 is detected by medium detector 32 and is conveyed by discharge roller pairs 16 and 18. The sheet is then discharged from medium outlet 17 so as to be stacked in stacker 25a.

Next, fan unit 40 will be described.

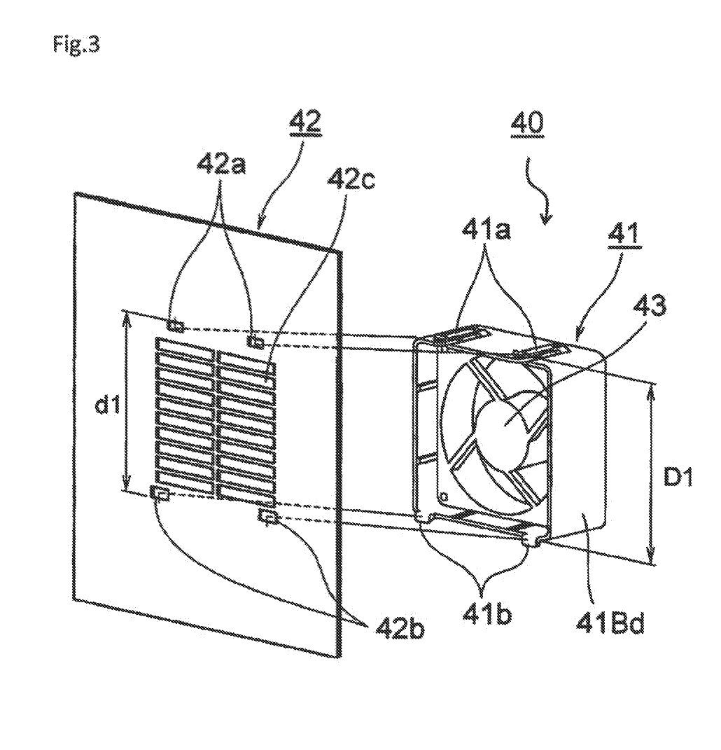

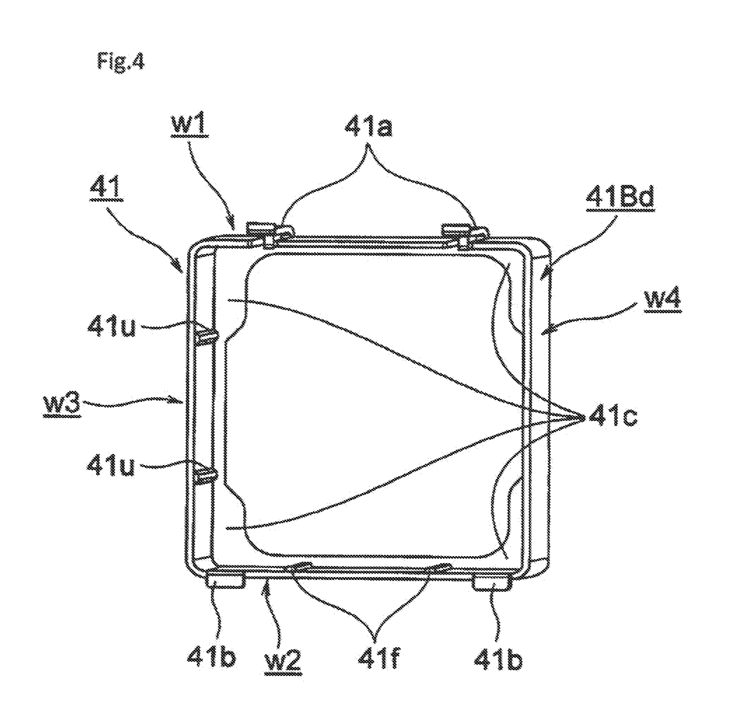

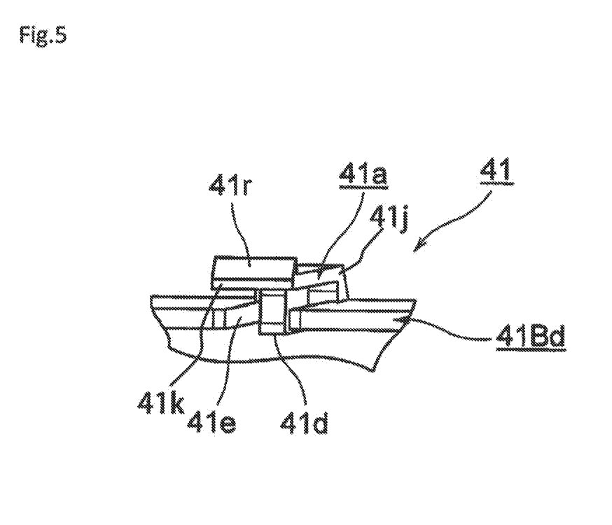

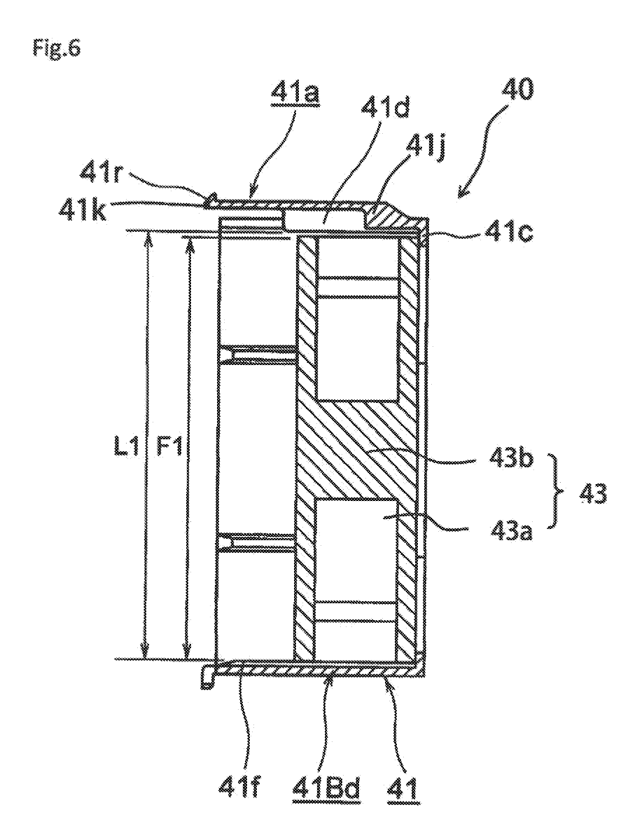

FIG. 3 is an exploded perspective view of the rotor support mechanism of the first embodiment, illustrating a state where fan unit 40 is attached. FIG. 4 is a perspective view of fan holder 41 of the first embodiment. FIG. 5 is a perspective view of a part of fan holder 41 of the first embodiment. FIG. 6 is a sectional view of fan unit 90 of the first embodiment.

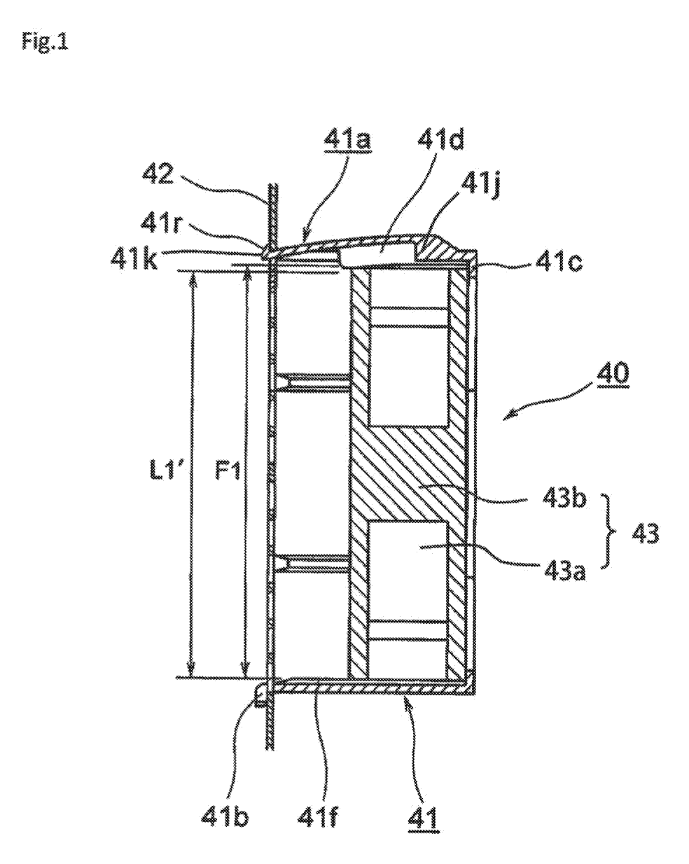

As shown in the figures, fan unit 40 includes: fan holder 41 serving as a support member; and ventilation fan 43, serving as an operable unit, to be supported by fan holder 41. A rotor support mechanism comprises: housing member 42, serving as a base, which is a part of housing 25 of image formation apparatus 10; and fan unit 40 to be attached to housing member 42. Fan 43 includes rotor 43a or a fan rotor and casing 43b rotatably supporting rotor 43a, as shown in FIG. 1.

Fan holder 41 is made of, for example, plastic which is flexibly deformable. Fan holder 41 includes: fan holder body 41Bd, serving as a support member main body, configured to accommodate therein or loosely fit therein fan 43; claws 41b (or hooks), serving as a first engagement part or a positioning part, formed integrally with fan holder body 41Bd; and latches 41a, each of which has claw 41r (or a hook) serving as a second engagement part, formed integrally with fan holder body 41Bd. Fan holder body 41B is formed in a tubular shape (a rectangular tubular shape in this embodiment) having an opening at a front end (that is, a housing member's side end) and an opening at a rear end (that is, an end on the opposite side). Fan holder body 41Bd is formed with wall part 41c (a rim or a flange) extending inwardly from the inner circumference of the rear opening end. Wall part 41c, serving as a positioning part or a stopper, is configured, when fan 43 is accommodated in fan holder body 41Bd, to be in contact with the rear end of fan 43, thereby positioning fan 43 in the axial direction.

In other words, fan holder body 41Bd includes: a tubular portion including top wall w1 serving as a first wall, bottom wall w2 serving as a second wall, side wall w3 serving as a third wall, and side wall w4 serving as a fourth wall; and wall part 41c (rim) formed at the inner circumference of the rear opening end of the tubular portion. Sections of wall part 41c (rim) that is in the vicinity of its four corners extend further inward than the other sections of wall part 41c (rim). Each latch 41a serves as an attachment part, being a flexible member, or a flexible arm. Latches 41a are formed at plural locations (two locations in the embodiment) of top wall w1 and each latch 41 has a long strip shape. Claws 41b, serving as the first engagement parts or the positioning parts, are formed at multiple locations (two locations in the embodiment) of bottom wall w2. Claws 41b are projected pieces extending slightly frontward from the front end of bottom wall w2 and then extending outwardly (downwardly) to a position lower than the bottom wall w2. The inner surface of bottom wall w2 has plural (two in the embodiment) ribs 41f, serving as a projection to be in contact with fan 43, extending from the rear end to the front end of bottom wall w2. The inner surface of each of side walls w3 and w4 has plural (two in the embodiment) ribs 41u, serving as projections to position fan 43 in the horizontal direction, extending from the rear end to the front end thereof. Note that in FIG. 4, ribs 41u of side wall w3 can be seen whereas ribs 41u of side wall w4 cannot be seen.

Latch 41a includes a flexible arm extending from the fan holder body 41Bd, whose rear end 41j (a fixed end or a base end) is connected to and supported by fan holder body 41Bd, and whose front end 41k (a free end or a fore-end) can be freely movable as latch 41 flexibly deforms. Front end (free end) 41k of latch 41a is located further frontward than the front end of fan holder body 41Bd and has a hook-shaped or triangle-shaped claw 41r, serving as the second engagement part, which is upwardly projected.

Fan holder body 41Bd has slits 41e at locations right below latches 41a. Each slit 91e extends from the rear end of a respective latch 41a to the front end of fan holder body 41Bd and has a width slightly wider than that of the respective latch 41a.

Latch 41a is located slightly above top wall w1 of fan holder body 41Bd in the state where no external force is applied to latch 41a. On the other hand, in the state where latch 41a is deformed downwardly by an external force, the front half of latch 41a can be located in slit 41e of top wall w1 and claw 41r of latch 41a can be located below the top surface of fan holder body 41Bd.

The lower surface (or the inner surface) of latch 41a has rib-like projection 41d serving as a press part. Rib-like projection 41d is projected downwardly from the lower surface and extends from the rear end to the middle section of latch 41a such that a part of projection 41d is located in slit 41e. Projection 41d is to be in contact with fan 43 when latch 41a is deformed downwardly in the state where fan 43 is accommodated in fan holder body 41Bd.

Housing member 42 has a predetermined shape, for example, a rectangle shape in the embodiment. The center section of housing member 42 is formed with opening 42c, or a ventilation hole, to discharge air from inside image formation apparatus 10 to outside image formation apparatus 10.

To attach fan holder 41 to housing member 42, housing member 42 includes: attachment holes 42a, serving as a second hole or a counterpart of the second engagement part, at locations corresponding to claws 41r (the second engagement parts) of latches 41a of fan holder 41; and attachment holes 42b, serving as a first hole or a counterpart of the first engagement part, at locations corresponding to claws 41b (the first engagement part) of fan holder 41.

The above-description satisfies the expression of “D1>d1”, where d1 is defined as a distance between an upper end of the inner circumference of attachment hole 42a and a lower end of the inner circumference of attachment hole 42b, and D1 is defined as a distance between the upper end of latch 41a (that is, the upper end of claw 41r) and the lower surface of bottom wall w2 in the state where fan holder 41 is not attached to housing member 42.

The above-description also satisfies the expression of “L1>F1”, where L1 is defined as the distance between the lower end of projection 41d and the upper end of ribs 41f in the state where fan holder 41 is not attached to housing member 42, and F1 is defined as the distance between the upper end of fan 43 and the lower end of fan 43 (that is, the upper ends of the ribs 41f). Note that in the state where fan holder 41 is not attached to housing member 42, projection 41d of latch 41a and fan 43 are spaced away and thus are not in contact with each other.

Next, the state where fan holder 41 is attached to housing member 42 will be described.

FIG. 1 is a sectional view of the rotor support mechanism of the first embodiment, illustrating the state where fan unit 40 is attached.

To attach fan holder 41 to housing member 42, first, fan 43 is inserted into fan holder body 41Bd until fan 43 is pressed against wall part 41c of fan holder body 41Bd. Thereby, fan 43 is accommodated in fan holder body 41Bd and is positioned in the axial direction with respect to fan holder body 41Bd.

Next, claws 41bof fan holder 41 are inserted in attachment holes 42b of housing member 42, thereby making claws 41b engaged with housing member 42. Then, latches 41a are inserted into attachment holes 42a as latches 41a are deformed, thereby making claw 41r engaged with housing member 42. In this state, latches 41a keep being deformed since distance d1 is less than distance D1.

Upon the deformation of each latch 41a, projection 41d of latch 41a moves downward such that projection 41d becomes inclined. Thus, distances L1′ and F1 satisfy the expression of “L1′<F1”, where L1′ is defined as the shortest distance between the upper ends of ribs 41f and the lowest point of projection 41d in the state where the holder 41 is attached to housing member 42.

Therefore, rib-like projection 41d of each latch 41a pushes fan 43 against bottom wall w2, while fan 43 receives a reaction force from ribs 41f of bottom wall w2 toward rib-like projection 41d of latch 41a. That is, rib-like projection 41d of latch 41a and ribs 41f of bottom wall w2 sandwiches fan 43 therebetween, which positions fan 43 with respect to fan holder 41 in the vertical direction. In this way, fan 43 is held by fan holder 41, as being positioned between projection 41d and ribs 41f.

Since projection 41d of latch 41a is inclined at a certain angle with respect to the upper surface of fan 43 in the state where fan holder 41 is attached to housing member 42, the press force of projection 41d of latch 41a against the upper end of fan 43 is applied in the vertical direction and in the horizontal direction. The horizontal component of the press force presses fan 43 against wall part 41c, while the vertical component of the press force presses fan 43 against rib 41f of bottom wall w2. Therefore, fan 43 is securely held by fan holder 41, preventing rattling of fan 43 against fan holder 41. Also, since the deformation of latch 41a creates the horizontal component of the press force from projection 41d of latch 41a, fan holder 41 does not need to have an inclined surface or a tapper to produce such a horizontal component to push fan 43 in the horizontal direction. This simplifies the structure of a die to mold fan holder 41.

Note that, in the embodiment, the sizes of projections 41d and ribs 41f are designed such that latches 41a can be further deformed more than their deformation in the state where fan 43 is positioned with respect to fan holder 41 in the vertical direction.

As described above, according to the first embodiment, the attachment of fan 43 to fan holder 41 and the attachment of fan holder 41 to housing member 42 are easily completed only by inserting fan 43 into fan holder body 41Bd and then attaching fan holder 41 to housing member 42 with deformed latches 41a. That is, this simplifies the operation of attaching and detaching fan 43 to and from housing 25 of image formation apparatus 10, when fan 43 needs to be replaced.

Further, according to the first embodiment, the embodiment does not require fixing elements such as a screw to attach fan 43 to fan holder 41 and to attach fan holder 41 to housing member 42. This simplifies the structure of fan unit 40 and reduces the manufacturing cost of fan unit 40.

Although, in the first embodiment, projection 41d of each latch 41a presses the upper end of fan 43 when each latch 41a is deformed, a modification of the embodiment may have, instead of latches 41a, a deformable contact part such that the contact part and ribs 41f can hold fan 43.

Although the first embodiment uses fan holder 41 serving as the support member, a modification of the embodiment may use, instead of fan holder 41, a duct, serving as a support member, to guide the air flow generated by fan 43.

### Second Embodiment

Next, the second embodiment of the invention will be

Next, the second embodiment of the invention will be described. Note that elements having the same configurations as those of the first embodiment are denoted by the same reference numbers and the effects achieved by the same configuration are omitted.

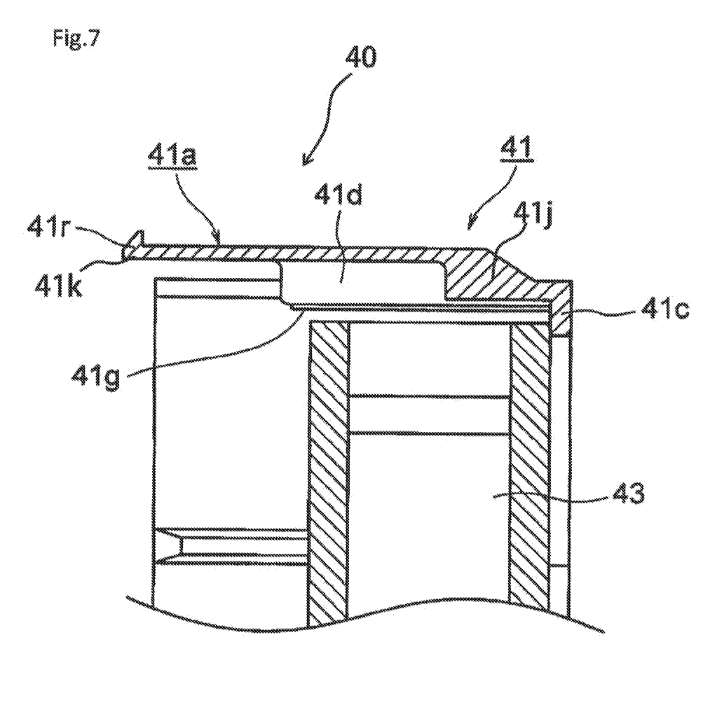

FIG. 7 is a sectional view illustrating a part of fan unit 40 according to the second embodiment.

The second embodiment includes foam member 41g, serving as an elastic member or a cushioning member, covering the lower surface of projection 41d. Thus, in the state where fan 43 is sandwiched between projections 41d and ribs 41f (see, FIG. 1), foam member 41g is slightly deformed to produce a bias force. This improves the prevention of rattling of fan 43 against fan holder 41.

### Third Embodiment

Next, the third embodiment of the invention will be described. Note that elements having the same configurations as those of the first and second embodiments are denoted by the same reference numbers and the effects achieved by the same configuration are omitted.

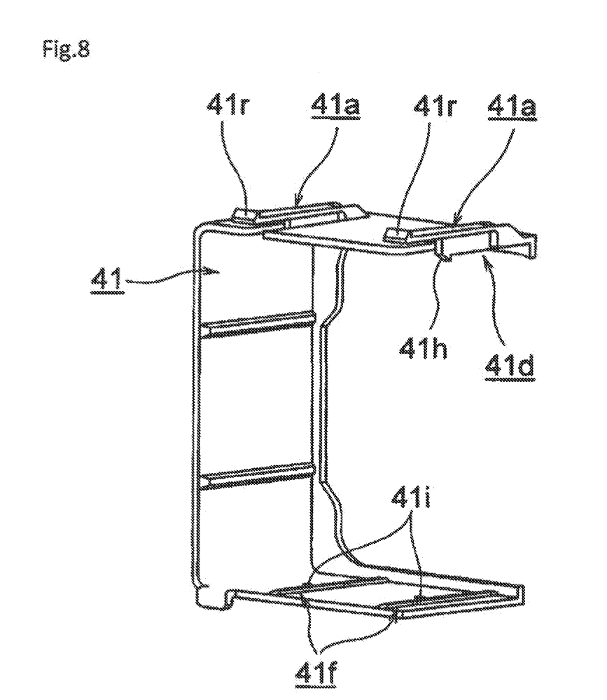

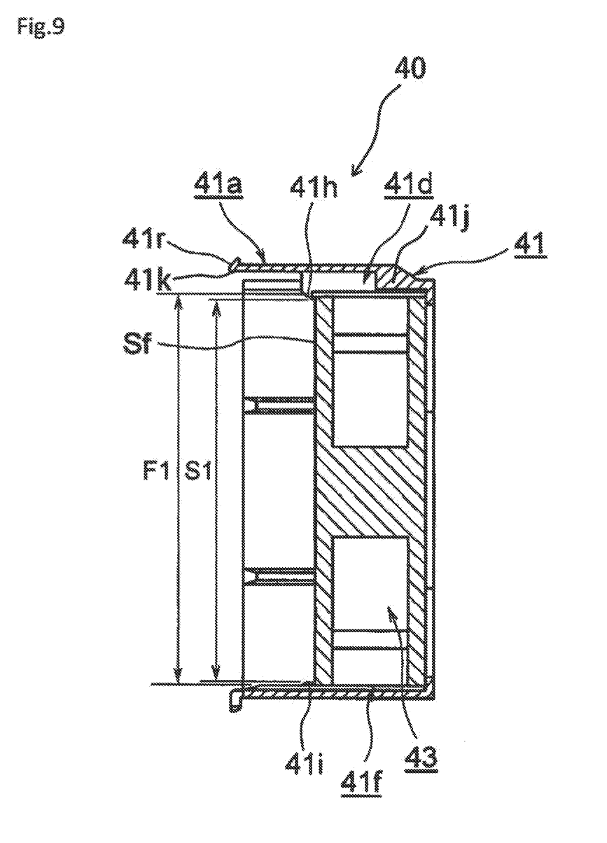

FIG. 8 is a perspective view illustrating a part of fan holder 41 according to the third embodiment. FIG. 9 is a sectional view of fan unit 40 according to the third embodiment.

In the third embodiment, stopper 41h, serving as a first lock part, is projected downwardly from the front end of projection 41d, and stopper 41i, serving as a second lock part, is projected upwardly from rib 41f of bottom wall w2 at a position opposed to stopper 41h.

This described structure satisfies the expression of “S1<F1”, where S1 is defined as the distance between the upper end of stopper 41h and the lower end of stopper 41i, and F1 is defined as the distance between the upper end and the lower end of fan 43 in the state where fan holder 41 is not attached to housing member 42. The difference between distances F1 and S1 is approximately 1 [mm].

Note that the positions of stoppers 41h and 41i are designed such that front face Sf of fan 43 is not in contact with the rear ends of stoppers 41h and 41i in the state where fan 43 in fan holder 41 is in contact with wall part 41c (see, FIG. 1).

Like the first embodiment, the described structure satisfies the expression of “L1>F1”, where L1 is defined as the distance between the lower end of projection 41d and the upper end of ribs 41f in the state where fan holder 41 is not attached to housing member 42, and F1 is defined as the distance between the upper end of fan 43 and the lower end of fan 43 (that is, the upper ends of the ribs 41f).

Next, the state where fan holder 41 is attached to housing member 42 will be described.

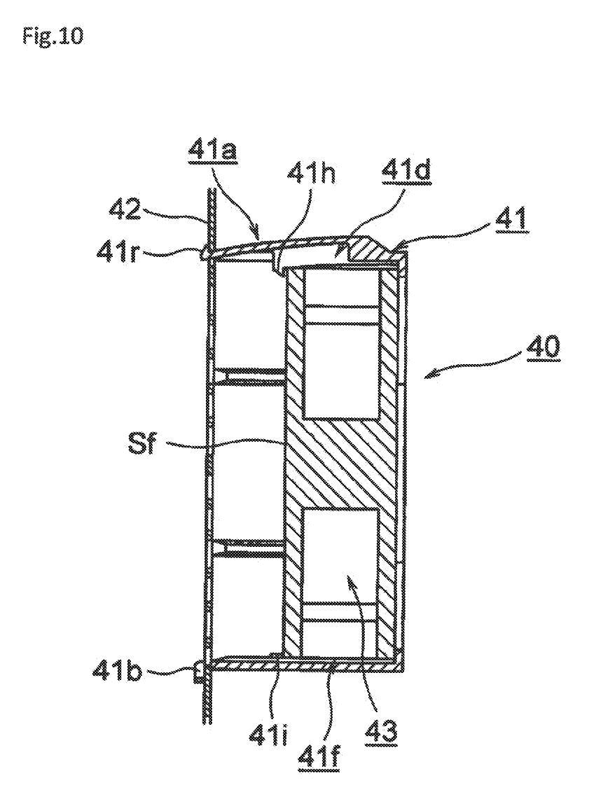

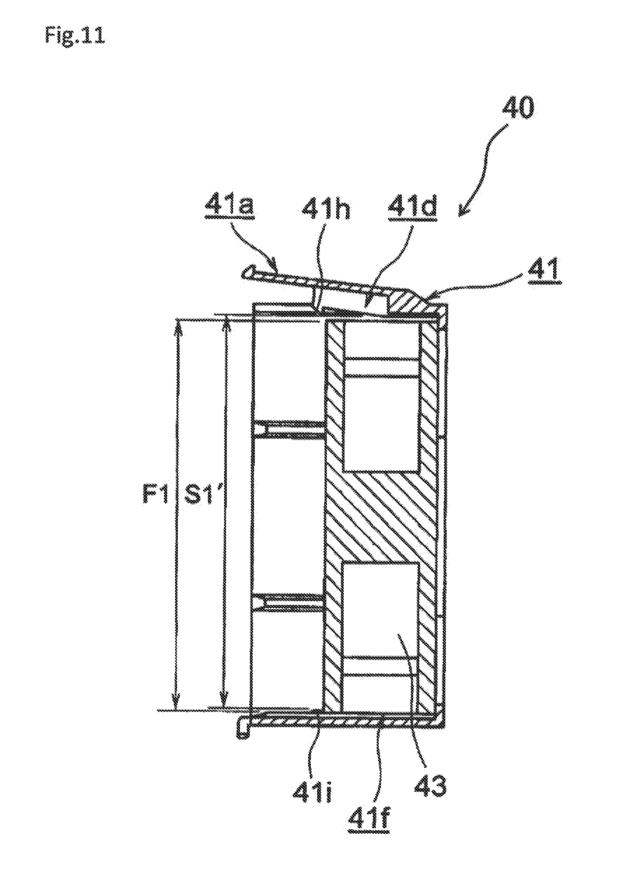

FIG. 10 is a sectional view of the rotor support mechanism according to the third embodiment, illustrating the state where fan unit 40 is attached. FIG. 11 is a view for explaining the method of attaching and detaching fan 43 to and from fan holder 41 according to the third embodiment.

In the third embodiment, to attach fan holder 41 to housing member 42, first, fan 43 is inserted into fan holder 41 until fan 43 is stopped by wall part 41c. Thereby, fan 43 is accommodated in fan holder 41 and positioned in the axial direction with respect to fan holder 41. Next, claws 41b, serving as the first engagement parts, of fan holder 41 are inserted into attachment holes 42b of housing member 42, serving as the first holes or the counterparts of the first engagement parts, so that claws 41b are engaged with housing member 42. Next, claws 41r, serving as the second engagement parts, of latches 41a are inserted into attachment holes 42a, serving as the second holes or the counterparts of the second engagement parts, as latches 41 are deformed. Thereby, claws 41r are engaged with housing member 42. In this state, since distance d1 is shorter than distance D1, latches 41a keep being deformed.

When latches 41a are deformed, projections 41d of latches 41a move downward such that projections 41d become inclined. Thus, like the first embodiment, projections 41d of latches 41a push fan 43 toward bottom wall w2, and fan 43 receives a reaction force from ribs 41f of bottom wall w2 toward projections 41d of latches 41a. That is, fan 43 is positioned between projections 41d of latches 41a and ribs 41f of bottom wall w2, thereby holding fan 43 in fan holder 41 while positioning fan 43 with respect to fan holder 41 in the vertical direction. In this state, since projections 41d of latches 91a are inclined at a certain angle with respect to the upper surface of fan 43, the press force from projections 41d against the upper surface of fan 43 includes a vertical component and a horizontal component. The horizontal component of the press force presses fan 43 toward wall part 41c, thereby front face Sf of fan 43 is spaced away from, and not in contact with, the rear ends of stoppers 41h and 41i.

Note that, upon inserting (attaching) fan 43 to fan holder 41 or upon ejecting (detaching) fan 43 from fan holder 41, latches 41a are made to be flexibly deformed in the upward direction (the direction away from fan 43) until distance S1′ between the lower end of stopper 41h and the upper end of stopper 41i is greater than distance F1 between the upper end and the lower end of fan 43 (S1′ >F1), as shown in FIG. 11. Therefore, by flexibly deforming latches 41a, fan 43 can be easily attached and detached to and from fan holder 41.

As described above, the third embodiment has stopper 41h formed at projections 41d and stopper 41i formed at ribs 41f such that distance S1' between the lower end of stopper 41h and the upper end of stopper 41i is shorter than distance F1 between the upper end and the lower end of fan 43. This structure prevents fan 43 from falling off from fan holder 41 after fan 43 is inserted in fan holder 41.

### Fourth Embodiment

Next, the fourth embodiment of the invention will be described. Note that elements having the same configurations as those of the first to third embodiments are denoted by the same reference numbers and the effects achieved by the same configuration are omitted.

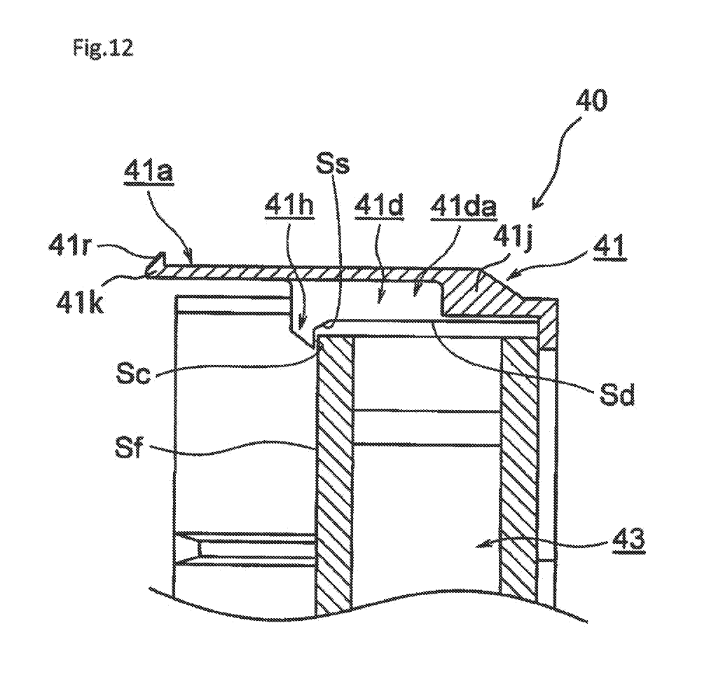

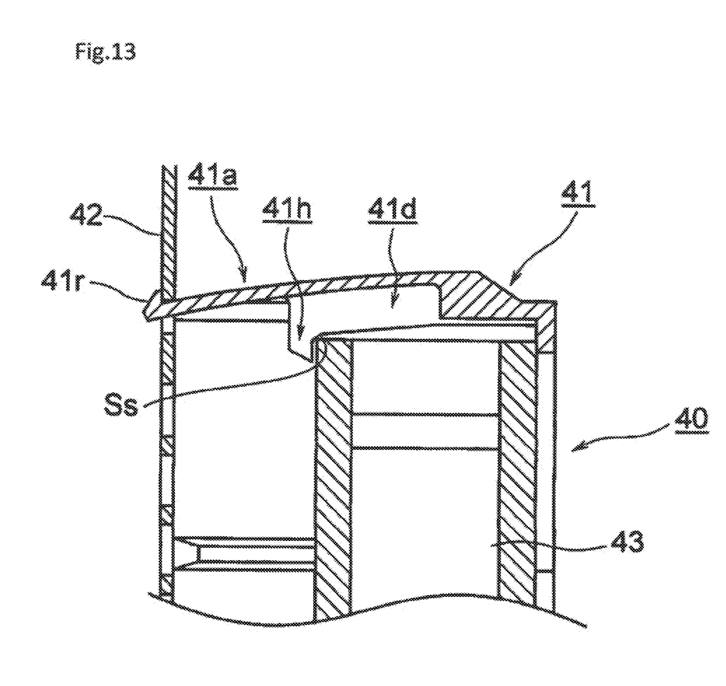

FIG. 12 is a sectional view of a part of fan unit 40 according to the fourth embodiment. FIG. 13 is a sectional view of a part of the rotor support mechanism of the fourth embodiment, illustrating a state where fan unit 40 is attached.

The difference between the third embodiment and the fourth embodiment is that, in the fourth embodiment, projection 41d is formed with inclined surface Ss at the base portion of the stopper 41h. Inclined surface Ss is formed at the corner between lower surface Sd of main body 41da of projection 41d and vertical surface Sc of stopper 41h, which is to be opposed to front surface Sf of fan 43, such that inclined surface Ss is inclined with respect to lower surface Sd and vertical surface Sc and connects lower surface Sd and vertical surface Sc.

When fan unit 40 is attached to housing member 42 by inserting claws 41b of fan holder 41 in attachment holes 42b of housing member 42 and inserting claws 41r of latches 41a into attachment holes 42a of housing member 42, as latches 41a deform, fan 43 is positioned between projections 41d of latches 41a and ribs 41f of bottom wall w2 (see, FIG. 1), whereby fan 43 is held by fan holder 41. In this state, inclined surface Ss of each projection 41d is in press contact with the upper end of fan 43 in the fourth embodiment, whereas lower surface Sd of each projection 41d is in press contact with the upper end of fan 43 as in the first embodiment. An angle between inclined surface Ss of projection 41d and the upper end of fan 43 when inclined surface Ss is in press contact with the upper end of fan 43 is greater than an angle between lower surface Sd of projection 41d and the upper end of fan 43 in the first embodiment. Thus, the fourth embodiment has a larger horizontal component of the press force from projection 41d (inclined surface Ss) against fan 43 than the first embodiment. That is, fan 43 is pressed against wall part 41c serving as the stopper with a larger force, thereby fan 43 is more securely held in fan holder 41.

### Fifth embodiment

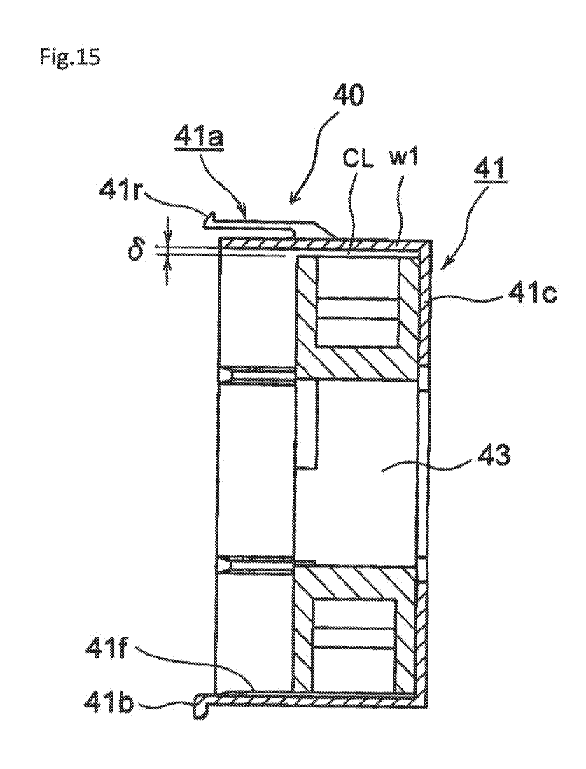

Next, the fifth embodiment of the invention will be described. Note that elements having the same configurations as those of the first to fourth embodiments are denoted by the same reference numbers and the effects achieved by the same configuration are omitted. housing member 52 of the fifth embodiment. FIG. 15 is a sectional view illustrating fan unit 40 of the fifth embodiment.

The difference between the fifth embodiment and the first embodiment is that in the fifth embodiment, fan holder 41 does not include projections 41d serving as the press parts whereas housing member 52, serving as a base or an attachment base, which is a part of housing 25 of image formation apparatus 10 (see, FIG. 2), includes projections 52c serving as press parts. Plural (two in the embodiment) projections 52c, which serve as flexible members, are projected from inside surface S1 of housing member 52 (an inside surface of housing 25) at a position lower than attachment hole 42a (in the vicinity of attachment hole 42a) and extend toward fan holder 41. Each projection 52c is a flat-plate and may be formed by cutting a part of housing member 52 to make a long strip piece and bending the strip piece.

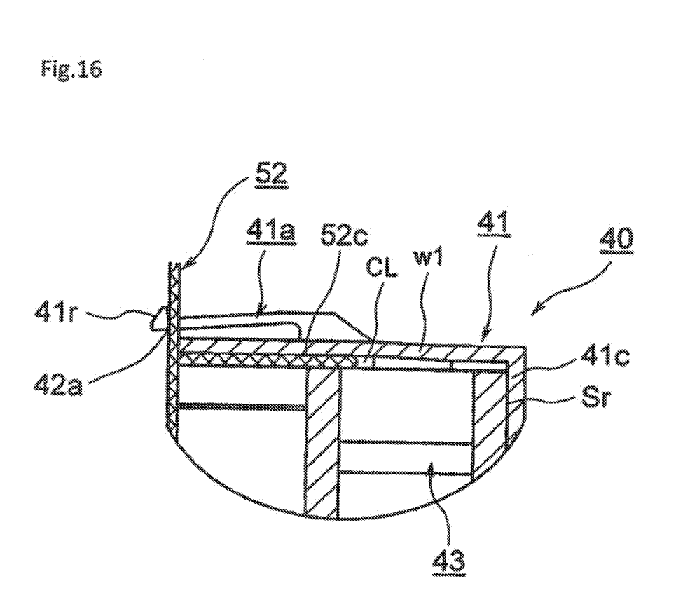

When fan unit 40 is attached to housing member 52, projections 52c are pressed into gap CL between fan 43 and top wall w1 of fan holder 41 (see, FIG. 16).

Where the thickness of gap CL between fan 43 and top wall w1 of fan holder 41 is defined as “δ” and the thickness of projection 52c is defined as “h”, the expression of “1.2*δ≦h≦1.5 *δ” is satisfied.

The fore-end of each projection 52c is formed with an unillustrated chamfered face, serving as an insertion guide, to facilitate the press-insertion of projections 52c into gap CL.

FIG. 16 is a sectional view of a part of the rotor support mechanism of the fifth embodiment, illustrating the state where fan unit 40 is attached.

In the fifth embodiment, to attach fan 43 to housing member

In the fifth embodiment, to attach fan 43 to housing member 52, first, fan 43 is inserted in fan holder 41 until fan 43 is pressed against wall part 41c. Thereby, fan unit 40 is assembled wherein fan 43 accommodated in fan holder 41 is positioned with respect to fan holder 41 in the axial direction.

Next, claws 41b of bottom wall w2 of fan holder 41 are inserted into attachment holes 92b of housing member 42, and thereby claws 41b of fan holder 91 are engaged with housing member 52. Then, claws 41r of latches 41a are inserted into attachment holes 42a as latches 41a are elastically deformed, and thereby claws 41r of fan holder 41 are engaged with housing member 52. In this state, since distance d1 is less than distance D1, latches 41a stay being deformed.

When fan unit 40 is attached to housing member 52, projections 52c of housing member 52 are press-inserted into gap CL between top wall w1 of fan holder 41 and the upper surface of fan 43. This press-insertion of projections 52c into gap CL presses fan 43 toward bottom wall w2 (see, FIG. 4) of fan holder 41, as a reaction force from ribs 41f of bottom wall w2 presses fan 43 against top wall w1 of fan holder 41 via projections 52c of housing member 52. Note that since fan holder 41 is formed of plastic, resin, or the like, which have elasticity, top wall w1 of fan holder 41 is deformed upon the press-insertion of projections 52c into gap CL.

According to the fifth embodiment, as described above, upon the attachment of fan holder 41 to housing member 52, projections 52c of housing member 52 are inserted into gap CL between fan holder 41 and the fan 43. With this, fan 43 is pressed between bottom wall w2 and top wall w1 with projections 52c of housing member 52, and is pressed against wall part 41c, thereby preventing rattling of fan 43 against fan holder 41.

Further, according to the fifth embodiment, rattling of fan 43 against fan holder 41 and rattling of fan holder 41 against housing member 52 are prevented with a smaller deformation of latches 41a than that of the first to fourth embodiment. Therefore, an excessive deformation of latches 41a due to variations of components 43, 41, and 52 in size is prevented. This suppresses deterioration of latches 41a.

Although thickness h of each projection 52c is constant from the fore-end to the base end of each projection 52c in the fifth embodiment, projections 52c may have a wedge shape wherein thickness h of each projection 52c gradually increases from the fore-end to the base end of projection 52c.

Although projections 52c are formed integrally with the main body of housing member 52 in the fifth embodiment, projections 52c may be made of a separate member from the main body of housing member 52 and be connected to the main body of housing member 52.

A printer has been described as an image forming apparatus in the above embodiments. However, those embodiments can be employed to a copy machine, a facsimile machine, a multi-functional peripheral/printer, and the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A rotor support mechanism comprising:
an operable unit including a rotor and a casing rotatably supporting the rotor;
a support member including a support member main body configured to accommodate therein the operable unit and an attachment part to attach the support member main body to a base; and
a press part configured, when the support member having the operable unit accommodated therein is attached to the base, to press the operable unit to hold the operable unit in the support member main body.

2. The rotor support mechanism according to claim 1, wherein
The press part configured, when the support member having the operable unit accommodated therein is attached to the base, to press the operable unit to a part of the support member main body thereby sandwiching the operable unit between the press part and the part of the support member main body.

3. The rotor support mechanism according to claim 1, wherein
the attachment part includes a base end connected to the support member main body and a fore-end formed with an engagement part configured to be engaged with the base, and
the attachment part is formed with the press part between the base end and the fore-end of the attachment part.

4. The rotor support mechanism according to claim 3, wherein
the attachment part includes a first face, and a second face configured as a reverse side of the first face, wherein the engagement part is formed on the first face of the attachment part and the press part is formed on the second face of the attachment part.

5. The rotor support mechanism according to claim 1, wherein
an inner surface of the support member main body is formed with projection at a position opposite to the press part.

6. The rotor support mechanism according to claim 5, wherein
a shortest distance between the press part and the projection is less than a width of the operable unit when the support member with the operable unit accommodated therein is attached to the base.

7. The rotor support mechanism according to claim 5, wherein
a shortest distance between the press part and the projection is greater than a width of the operable unit when the support member with the operable unit accommodated therein is not attached to the base.

8. The rotor support mechanism according to claim 1, wherein
the press part includes a cushioning member at a position facing the operable unit.

9. The rotor support mechanism according to claim 1, wherein
the press part is formed with a lock part configured to prevent the operable unit accommodated in the support member main body from moving in a direction opposite to an insertion direction of the operable unit into the support member main body.

10. The rotor support mechanism according to claim 9, wherein
the press part is formed with an inclined surface at a base portion of the lock part.

11. The rotor support mechanism according to claim 1, wherein
the press part is configured as a projection projected from the base, and the projection from the base is configured to be inserted in a gap between the support member main body and the operable unit.

12. The rotor support mechanism according to claim 1, wherein the operable unit is a fan.

13. The rotor support mechanism according to claim 1, wherein the support member is a duct.

14. An image formation apparatus comprising the rotor support mechanism according to claim 1.

15. A rotor support mechanism comprising:
an operable unit including a rotor and a casing rotatably supporting the rotor; and
a support member configured to be attached to a base and including a support member main body configured to accommodate the operable unit therein, and a flexible member configured to deform toward an inside of the support member main body during attachment of the support member to the base.

16. The rotor support mechanism according to claim 15, wherein
the flexible member includes a base end connected to the support member main body and a fore-end formed with an engagement part configured to be engaged with the base.

17. The rotor support mechanism according to claim 15, wherein
the flexible member is formed with a press part configured to make contact with the operable unit when the support member with the operable unit accommodated therein is attached to the base.

18. The rotor support mechanism according to claim 15, wherein
the flexible member includes a first face and a second face configured as a reverse side of the first face, wherein the first face comprises an engagement part configured to engage with the base, and the second face comprises a press part configured to be in contact with the operable unit when the support member with the operable unit accommodated in the support member main body is attached to the base.

19. An image formation apparatus comprising the rotor support mechanism according to claim 15.

20. The image formation apparatus according to claim 14, further comprising:
a housing comprising the base;
an image formation unit provided inside of the housing and configured to form a developer image;
an image transfer unit provided inside of the housing and configured to transfer the developer image to a medium; and
a fixation unit provided inside of the housing and configured to fix the developer image to the medium by heating the medium having the developer image thereon.
